(19) United States
(12) Patent Application Publication
(10) Pub. No.: US 2020/0090236 A1
(43) Pub. Date: Mar. 19, 2020

(54) Apparatus and System for Mining Billing Data From a Device, and Corresponding Method Thereof

(71) Applicant: Time Miner, LLC, Nashville, TN (US)

(72) Inventors: Sean J. Martin, Nashville, TN (US); John Pierce Schubert, Jr., Nashville, TN (US); Robert H. Laird, Jr., Nashville, TN (US)

(21) Appl. No.: 16/465,728

(22) PCT Filed: Dec. 1, 2017
(86) PCT No.: PCT/US2017/064226

§ 371 Date: May 31, 2019

Related U.S. Application Data
(60) Provisional application No. 62/428,741, filed on Dec. 1, 2016.

(51) Int. Cl. G06Q 30/04; G06Q 10/10

(52) U.S. Cl. CPC G06Q 30/04; G06Q 10/1091

(57) ABSTRACT

Apparatuses, systems, and methods for mining time data are provided. Implementations consistent with the present disclosure provide for mining devices for time spent on behalf of clients-time that would otherwise be un-captured, unbilled time and money, and ensure that a user is properly compensated for all they do. Operations consistent with the present disclosure include selecting at least one billing criteria by a user of a mobile device, searching the mobile device for stored electronic communication data related to the at least one billing criteria, returning at least one matched electronic communication from among the stored electronic communication data related to the at least one billing criteria, assigning at least one of a time value and a billing value to the at least one matched electronic communication, and performing at least one of timekeeping and billing based up-on the assigned at least one time value and billing value.

### TECHNICAL FIELD

The present disclosure relates generally to an apparatus and system for mining data contained on a device (e.g., a user's mobile device) and calculating corresponding billable time revenue as a result of such data and corresponding methods thereof.

### BACKGROUND ART

Currently, individuals who bill their time by the hour, such as lawyers, accountants, and other professionals rely upon and increasingly use their mobile devices every day to communicate and to perform tasks on behalf of their clients. Often, however, the time they spend on these devices does not get billed to those clients.

This phenomena has nothing to do with laziness, but rather with the manner in which most individuals use their mobile devices: in the car, at the airport, or in a restaurant or bar, for example. In other words, they use their devices on the go, and either don't have access to their time and billing software, or it is inconvenient to access it at that moment, or they simply forget to bill for the communication or the task, with their mind on traffic, their flight, or their dinner. They may email themselves to remind themselves to bill the time, but this is the exception and not the rule. Rather the rule is, the time spent is forever lost.

The obvious consequence of not billing for communications or tasks performed on behalf of clients is lost revenue. For the professional who bills his time at $300.00/hour in six (6) minute increments (or 1/10ths of an hour), the failure to bill for three short texts to three separate clients will cost the professional $90.00. For a professional who bills by the quarter hour, the lost revenue amounts to $225.00. These are unacceptable and completely avoidable losses.

A less obvious consequence, and one that manifests only in the aggregate, is that the amount and quality of work produced, which is relied upon by staff providing assistance in doing and producing, becomes grossly disproportionate with the amount of fees charged for doing so.

TimeClock is an example of a currently available time tracker. TimeClock functions as a total time and billing solution (e.g., as a whole software package). It tracks time using a timer, tracks expenses, allows for entries for each, and generates invoices. However, TimeClock does not “mine the device” for communications that are not associated with an already-created or already-running time entry. TimeClock's interface is very much like standard desktop time/billing software (e.g., having too many buttons and being too complicated for most users). Furthermore, current versions of TimeClock run on a desktop computer as opposed to a mobile device, again, functions as a complete time and billing solution.

Like TimeClock, Intuit Time Capture appears to be a complete time and billing solution. Also like TimeClock, this product appears to track time on a phone, but only using a timer. Time Capture doesn't “mine the device” for time entries, it instead requires you to start and stop a clock and create a time entry. Time Capture allows the tracking of expenses, etc. and appears to integrate and synchronize entries with Quickbooks, which some companies (although not many law firms) use for time and billing beyond accounting. Time capture appears to be a solution for teams in the field who are all working on the same project and who need to track time, tasks, and expenses on the project, which are being run and managed, and ultimately billed, by a host company who is using Quickbooks.

One reason that neither TimeClock nor Time Capture meet the real needs of lawyers and other professionals who use mobile devices for work is because they are set up on the assumption that those individuals are using best billing practices. In other words, they are built according to the way professionals SHOULD go about tracking billable time, and not the way they actually do. Starting a timer before a mobile communication and stopping it when complete and making a billing entry is a best practice. In theory this is how time should be captured and entered. In practice, however, many lawyers and professionals do not follow this practice. Rather, many may answer their phone or send a text, and then get back to doing what they were doing previously, such as driving or sitting in court. Later, when the lawyer or professional returns to the office, he or she will have forgotten those mobile communications, which might never make their way to a bill. This is why so much time is lost on devices.

Intapp Time Capture and Chrometa (available at www.chrometa.com) each provide fairly complete time and billing software packages, in that they have a desktop component as well as an app. These applications appear to provide stand alone time and billing software, or to be a supplement to the software actually used. This is because of the way they both appear to always work: in the background, and in the foreground if necessary.

These products operate similar to spy programs. They run in the background and keep track of active applications and/or active windows. For example, if you spend 45 minutes on CNN.com, five minutes writing an email to someone, and then another 45 minutes on ESPN.com, each of these products records those tasks with varying level of description. At the end of the day, a report will be generated, presumably for every single action performed that day on a computer or mobile device. These programs claim to be able to integrate with other time and billing programs and that each product can generate reports or invoices. In this respect, the software is operating in the foreground. The mobile apps on each appear to work the same way: (1) the apps run in the background and report to the main software everything you did that day, from twitter to actual work, and (2) reports from either the desktop app or the mobile app appear to be in line-item format, perhaps a Microsoft Excel format, giving the date, time, and a short description.

In contrast to solutions provided by Intapp Time Capture and Chrometa, many lawyers and professionals don't want spyware running in the background and recording everything they do. Further, even if one or both of these can, as they claim, identify client matters by using “keywords” or making an assumption based on the “active” program or window, accomplishing this looks to be a challenge at best, and these products do not accomplish the goals of the present disclosure. For example, the interfaces are very complicated, and their use requires a lawyer or professional to run multiple time and billing programs. Most lawyers are not going to bother to learn tricks and workarounds to use these products, and thus will be unlikely to discover or properly identify numerous features. Further, lawyers and professionals do not want to use a second complicated time and billing program. It's bad enough dealing with just one time and billing program and, at the end of the day, these products are too big, too clunky, and try to do too much. These programs do not fully address issues relating to lost time on mobile devices for a number of reasons, including:

1. No one wants spyware running on their devices recording everything they do. but more importantly; and

2. This software, like the other options, ignores the way lawyers and other professionals use their mobile devices. In order for time to be tracked or captured by Time Capture or Chrometa, the program/app/product has to be turned on and running in the background. The lawyer or professional must take the affirmative step of opening the time keeping program before they want to keep time, and that is just not how people use their mobile devices.

### DISCLOSURE OF THE INVENTION

Embodiments of the present invention provide apparatuses, systems, and methods for mining data contained on a device (e.g., a user's mobile device) and calculating corresponding billable time revenue as a result of such data and corresponding methods thereof.

Implementations consistent with the present disclosure provide for mining devices for time spent on behalf of clients—time that would otherwise be un-captured and/or unbilled, and ensure that a user is properly compensated for all that they do. This is not to say that every call or other communication on a user's cell phone must be billed. Rather, this is to suggest that, at the very least, the time spent on a matter should be recorded, even if it is not planned to be billed, so the client understands the time spent on his or her matter and appreciates the value of all work performed. This functions as a credibility-builder as much as it is a money-maker. In other words, inventions consistent with the present disclosure function as a value add which may pay for itself (even on the first use in some cases) and may help create value or revenue or both every single time it is used thereafter.

What is needed is a product which understands the way that lawyers and professionals use their devices and allows mining the device AFTER THE FACT for those communications and resulting revenue that would otherwise be lost. Inventions consistent with the present disclosure provide an “after the fact” processing capability, and provide the benefit of, and indeed money, from hindsight. It permits a lawyer or professional to not use best billing practices when they are mobile, but to still allow them to bill for all billable mobile time. This delivers revenue and time to the lawyer or professional and/or value to the client.

in sharp contrast to other options, implementations consistent with the present disclosure are designed for busy professionals, for procrastinators, and for the absent-minded-those people who put off the unpleasantness of billing until they return to the office where they can do it from the comfort of their chair with their desktop time and billing software and who forget to do so (some even every single day). Implementations consistent with the present disclosure may be used for those people who don't think to start a timer or open another program that works in the background to watch and record everything they do, only to have that information synchronized with a desktop version, stored in the cloud, put on an invoice, and possibly integrated with a wholly separate time and billing solution.

Stated simply, implementations consistent with the present disclosure are for most users who bill by the hour, and who use their mobile devices and need to be able to go back and quickly get a list of their business communications. More specifically, inventions consistent with the present disclosure may provide simplicity in a one-stop shop for time and billing.

According to one aspect of the present disclosure, provided is an apparatus for providing mined time information. The apparatus includes a display interface, the display interface being configured to convey a set of one or more billing criteria. The apparatus further includes an input module, the input module configured to receive a selection of at least one of the one or more billing criteria. A mining module is provided, the mining module being configured to obtain one or more electronic messages corresponding to the selected at least one of the one or more billing criteria. A billing module is provided and configured to perform at least one of timekeeping and billing based upon an assigned billing value corresponding to the selected at least one of the one or more billing criteria.

The apparatus may include a local storage storing at least one set of mineable data. The mining module may obtain from the local storage the one or more electronic messages corresponding to the selected at least one of the one or more billing criteria. The local storage of the apparatus may store at least one set of telephone call data, and the mining module may obtain the at least one set of telephone call data. The local storage of the apparatus may store at least one set of electronic mail data, and the mining module may obtain the at least one set of electronic mail data, the stored electronic communication data including electronic mail data.

The mining module of the apparatus may obtain the one or more electronic messages by accessing a data storage external to the mobile device and obtaining at least one set of electronic communication data. The stored electronic communication data may include telephone call data or electronic mail data.

Another aspect of the present disclosure relates to providing a non-tangible computer-readable storage medium having instructions stored thereon, which when executed by a processor perform the steps of: selecting at least one billing criteria by a user of a mobile device, searching for stored electronic communication data related to the at least one billing criteria, returning at least one matched electronic communication from among the stored electronic communication data relates to the at least one billing criteria, assigning at least one of a time value and a billing value to the at least one matched electronic communication, and performing at least one of timekeeping and billing based upon the assigned at least one time value and billing value.

The step of searching for stored electronic communication data may include searching the mobile device for locally-stored electronic communication data. The stored electronic communication data may include telephone call data or electronic mail data.

The step of searching for stored electronic communication data may include accessing a data storage external to the mobile device and obtaining at least one set of electronic communication data. The stored electronic communication data may include telephone call data or electronic mail data.

A further aspect of the present disclosure relates to a method of providing mining of time data on a computing device. The method includes selecting at least one billing criteria by a user of the computing device, searching for stored electronic communication data related to the at least one billing criteria, and returning at least one matched electronic communication from among the stored electronic communication data related to the at least one billing criteria. At least one of a time value and a billing value is assigned to the at least one matched electronic communication, and at least one of timekeeping and billing is performed based upon the assigned at least one time value and billing value.

The searching for stored electronic communication data may include searching the computing device for locally-stored electronic communication data. The stored electronic communication data may include telephone call data or electronic mail data.

The searching for stored electronic communication data may include accessing a data storage external to the computing device and obtaining at least one set of electronic communication data. The stored electronic communication data may include telephone call data or electronic mail data.

Numerous other objects, features, and advantages of the present invention will be readily apparent to those skilled in the art upon a reading of the following disclosure when taken in conjunction with the accompanying drawings.

### BRIEF DESCRIPTION OF THE DRAWINGS

FIG. 1 is a block diagram of a time mining system according to an exemplary embodiment.

FIG. 2 illustrates an exemplary operating method of a time mining system of an exemplary embodiment.

FIG. 3 illustrates a method of collecting and associating time data in accordance with an exemplary embodiment.

FIG. 4 illustrates a network configuration for implementing and mining an electronic communication according to aspects of the present disclosure.

### BEST MODE FOR CARRYING OUT THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

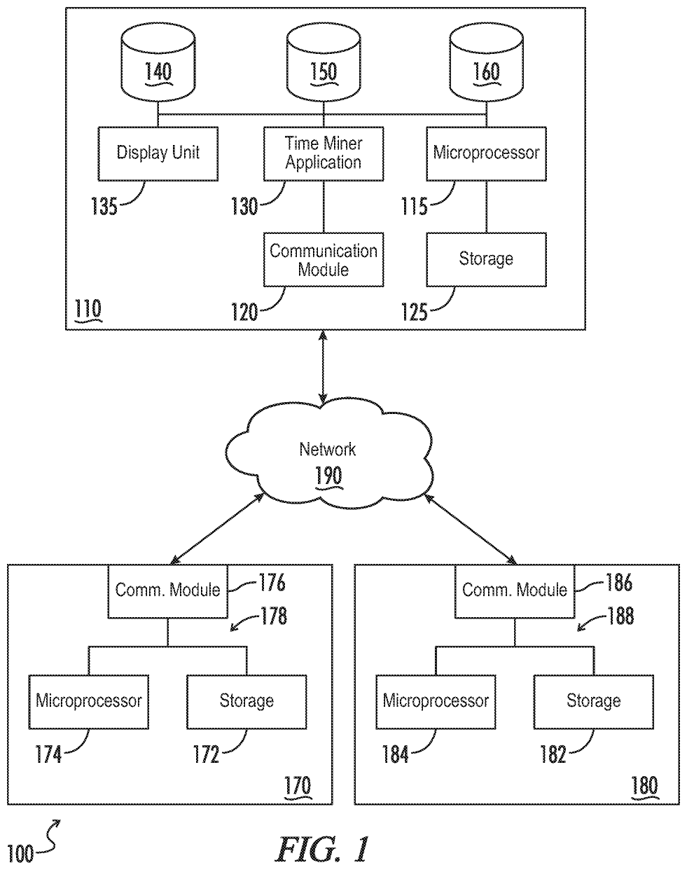

Referring generally to FIGS. 1-4, various exemplary apparatuses and associated methods according to the present disclosure are described in detail. Where the various figures may describe embodiments sharing various common elements and features with other embodiments, similar elements and features are given the same reference numerals and redundant description thereof may be omitted below.

Various embodiments of an apparatus according to the present invention may provide apparatuses, systems, and methods for mining data contained on one or more devices (e.g., on one or more mobile devices). Implementations consistent with the present disclosure may include a simple interface. A user may begin by selecting a Time Miner logo. When Time Miner opens. The user may hit “mine device,” watch a status indicator progress (e.g., an opaque circle of some color darken clockwise, or watch a clock wind, or watch a mining tool dig), and voila: a report of their billable communications may be created from the time that Time Miner began running, complete with a date, a duration, and one of a plurality of descriptions (e.g., “telephone conference w/[other party]” or “text message exchange with [other party]”, etc.). Optionally, an “email to/from with [other party] re: [subject line]” in one example.

Other parties may be identified in the report, and identifiable by Time Miner, because the user has populated Time Miner with contact information for work-related individuals. As such, Time Miner provides an “add contact” ability. In one exemplary embodiment, when a contact name is added, a user may be asked if they want to associate a matter with that particular contact. The report may include a field which identifies a particular matter which the communication was related to. This report may be exportable via email and/or text in various formats using at least one of a plurality of software programs. In one exemplary embodiment, a date field may be used so that Time Miner knows over what period to look for communications. In one exemplary embodiment, a separate button may provide a user with the option of running a report “since last billing cycle” or “since last time,” or the like.

FIG. 1 illustrates a block diagram of a time mining system 100 in accordance with an exemplary embodiment. The time mining system 100 includes at least one of a computing device 110, a server 170, and a remote device 180. Each of the computing device 110, the server 170, and the remote device 180 may be connected to a network 190. In one exemplary embodiment, the network 190 includes the Internet, a public network, a private network, or any other communications medium capable of conveying electronic communications. Connection between a communication module 120 of the computing device 110 and the network 190 is configured to be performed by wired interface, wireless interface, or a combination thereof, without departing from the spirit and the scope of the present disclosure. In one exemplary operation, the computing device 110 is configured to store one or more sets of instructions in a storage 125. The one or more sets of instructions may be configured to be executed by a microprocessor 115 of the computing device 110 to perform operations corresponding to the one or more sets of instructions.

In various exemplary embodiments, the computing device 110 is implemented as at least one of a desktop computer, a laptop computer, a smart phone, or any other electronic device capable of executing instructions. The microprocessor 115 is configured to take the form of a generic hardware processor, a special-purpose hardware processor, or a combination thereof. In embodiments having a generic hardware processor (e.g., as a central processing unit (CPU) available from manufacturers such as Intel and AMD), the generic hardware processor is configured to be converted to a special-purpose processor by means of being programmed to execute and/or by executing a particular algorithm in the manner discussed herein for providing a specific operation or result.

The computing device 110 is configured in various embodiments to be associated with a mobile user, and is capable of being transported, either during operation or while powered off. In one embodiment where the computing device 110 is a cellular telephone or smartphone, the computing device 110 is at least temporarily located at a client's premises. In various embodiments, the computing device 110 is configured to operate remotely, and is configured to obtain or otherwise operate upon one or more instructions stored physically remote from the computing device 110 (e.g., via client-server communications and/or cloud-based computing).

The computing device 110 includes at least one of a call database 140, a text database 150, and an e-mail database 160. Although described with reference to calls, texts, and e-mails, it should be appreciated that one or more of the databases 140, 150, and 160 may include any type of information or metadata relating to any set of data. For example, in one exemplary embodiment, the text database may be configured to store one or more sets of data or metadata relating to text messages, social media information, a telephone call log, an e-mail, or any other set of data or metadata associated with the computing device 110. Furthermore, although described with reference to three separate databases, it should be appreciated that two or more of the enumerated databases may be physically and/or logically stored in a single database. Still further, one or more of the databases 140, 150, and/or 160 may be implemented in whole or in part by a distributed or cloud-based storage, without departing from the spirit and the scope of the present disclosure.

The computing device 110 may include a display unit 135. The display unit 135 is embodied within the computing device 110 in one embodiment, and is configured to be either wired to or wirelessly-interfaced with the end user electronic device 200. The display unit 135 may be configured to operate, at least in part, based upon one or more operations of the Time Miner application 130, as executed by the microprocessor 115. Although operable using the display unit 135 of computing device 110, the Time Miner application may be capable of executing and operating using a plurality of devices/For example, one or more computing devices 110 may include smart phones, tablets, laptop computers, etc., each having different microprocessors 115, screen resolutions, memory sizes, etc., but each may be capable of executing the Time Miner application 130 after download and/or installation of at least a port of the Time Miner application 130 from the server 170.

The server 170 is configured to perform one or more operations corresponding to the time miner application 130. Although illustrated as a single server, the server 170 may be implemented as a plurality of servers or server elements, any of which may be located either within a single computing element or a plurality of computing elements. In one exemplary embodiment, the server 170 is configured to store at least a portion of an executable file, a portion of computer code, or other information associated with the Time Miner application 130, such that at least a portion of data corresponding to the Time Miner application is transmitted from the server 170 to the computing device 110 via the network 190. For example, the server 170 may perform one or more functions corresponding to an application store configured to provide an executable copy of the Time Miner application 130 to the computing device 110, either automatically or in response to a download request.

The server 170 may, in one exemplary embodiment, include a storage 172 configured to store at least a portion of data corresponding to the Time Miner application 130. In one embodiment, the at least a portion of data corresponding to the Time Miner application 130 may include an executable or installable file for use by the computing device 110. Additionally or alternatively, the at least one portion of data may contain or embody a link or other association with at least one file located remotely from the server 170. A microprocessor 174 of the server 170 is configured to execute one or more set of instructions in a manner similar to that described above with relation to microprocessor 115. The server 170 may further include a communication module 176. The communication module 176 may be configured to communicate via the network 190, for example using at least one of a wired and/or wireless communication path. One or more of the storage 172, the microprocessor 174, and the communication module 176 may be coupled via a bus 178. The bus 178 may be a conductive path in one exemplary embodiment, however any means of conveying at least a portion of a signal between two or more of the storage 172, the microprocessor 174, and/or the communications module 176 may be used as the bus 178 without departing from the spirit and the scope of the present disclosure.

The time mining system 100 may further include at least one remote device 180. The remote device 180 may be configured to transmit and/or receive data corresponding to the computing device 110 in various embodiments. The remote device 180 may include a storage 182, configured to store at least one of computer instructions and/or data or metadata associated with the Time Miner application 130 and/or computing device 110. A microprocessor 184 of the remote device 180 is configured to execute one or more set of instructions in a manner similar to that described above with relation to microprocessor 115. The remote device 180 may further include a communication module 186. The communication module 186 may be configured to communicate via the network 190, for example using at least one of a wired and/or wireless communication path. One or more of the storage 182, the microprocessor 184, and the communication module 186 may be coupled via a bus 188. The bus 188 may be a conductive path in one exemplary embodiment, however any means of conveying at least a portion of a signal between two or more of the storage 182, the microprocessor 184, and/or the communications module 186 may be used as the bus 188 without departing from the spirit and the scope of the present disclosure.

The Time Miner application 130 may be used in various embodiments to mine a computing device 110 for time corresponding to one or more clients and/or matters, and to capture otherwise lost time. In the case of professionals who bill by the hour, the Time Miner application 130 may be used to account and collect for otherwise lost billable time.

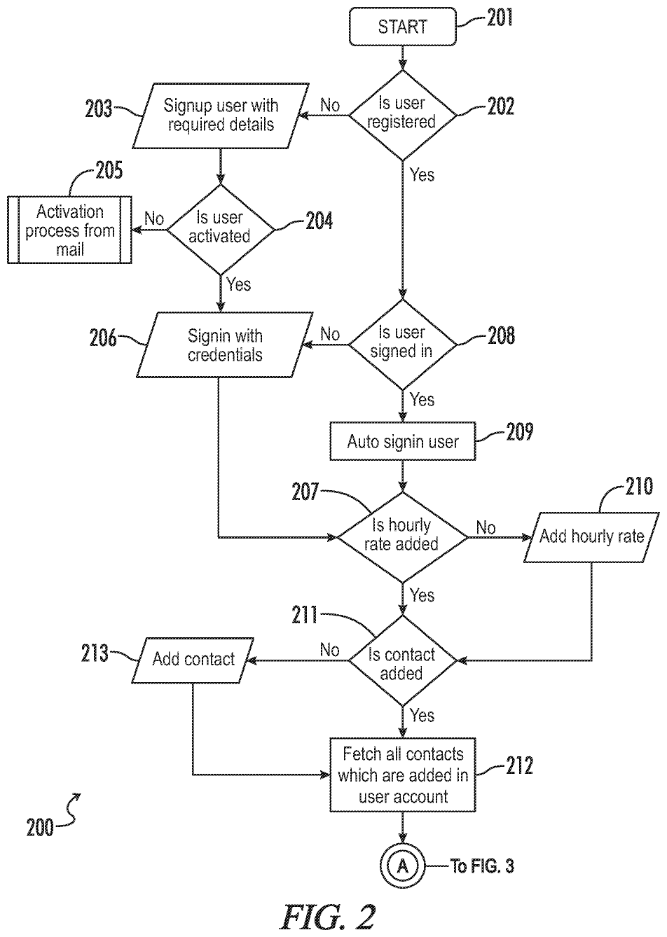

FIG. 2 illustrates an exemplary operating process of a time mining system of an exemplary embodiment. The process 200 begins at a step 201. The process continues to a step 202, where it is determined whether a user is registered. If a user is not registered, the user may be permitted to sign up for an account (e.g., with one or more required details) at a step 203. In one exemplary embodiment, the Time Miner application 130 may be configured to communicate with the server 170, the server 170 being configured to perform one or more registration steps. Additionally or alternatively, all or a portion of the registration process may be performed at the computing device 110 by the Time Miner application 130 (e.g., when operating in an offline or non-Internet enabled mode).

In one exemplary embodiment, the registration process may include an activation process, such as requiring a user to click on a link provided in an e-mail to the user, or any other activation method. It is determined at a step 204 whether the user is activated. If a user is not activated, the process may continue to a step 205, where the activation process is continued via e-mail. If it is determined at the step 204 that the user is activated, the process continues to step 206, where the user is permitted to sign in using one or more credentials associated with the registration process.

If it is determined at step 202 that the user is registered, the process continued to a step 208, where it is determined whether the user is signed in. If a user is not signed in, the process continues to the step 206, where the user signs in using one or more credentials associated with the registration process. If it is determined at the step 208 that the user is signed in, the process continues to a step 209, where the user may be automatically signed into the time mining system 100. The process then continues to a step 207.

It is determined at step 207 whether an hourly rate has been assigned. The assigned hourly rate may correspond, for example, to at least one of a saved or known contact identifier of a client (e.g., a telephone number or an e-mail address), a user of the Time Miner application 130, a client of the user of the Time Miner application 130, a particular type or length of assignment, time, or document, a means of transmission or receipt, or any other characteristic of at least one of the user of the Time Miner application 130, a person or organization associated with the user of the Time Miner application 130, a particular type, format, or content or a document or information, or any other characteristic. In various exemplary embodiments, the Time Miner application 130 may be configured to retrieve one or more potential entries by accessing application data from an application of the computing device 110. For example, the Time Miner application 130 may be preconfigured to interface with one or more application programs or with the knowledge or ability to gain the knowledge of how to access a data store associated with the one or more application programs to mine possible entries. Mined information may include, for example, information relating to telephone calls, information relating to text messages, information relating to e-mail messages, or any other electronic communication, document, or time spent relating to a client matter.

In one exemplary embodiment, the Time Miner application 130 is configured to operate according to one or more specific identifiers, which may be inserted into a data set (such as a voice call data packet or stream as data or metadata, or into a data transmission as data or metadata, for example by inserting or reading a specific identifier into an electronic communication such as a text message or e-mail). In one exemplary embodiment, the specific identifier is inserted into one or more e-mail subject lines or within the body of one or more e-mail messages to identify at least one of a billing setting, a matter number, a contact, a billing rate, or any other data configured to convey billing and/or time information. The specific identifier may be configured to be visible or invisible within data seen by a sender or receiver of a communication. For example, the specific identifier may be configured to be viewed by a sender of an e-mail or text message, but invisible to a receiver of the text message or e-mail.

If it is determined at the step 207 that an hourly rate has not been assigned, one or more hourly rates may be assigned, for example by the user of the time miner application 130 via the display unit 135 of the computing device 110. The process may then continue to a step 211. The process likewise continues to the step 211 when it is determined at the step 207 that an hourly rate is available. It is determined at the step 211 whether a contact has been added. In one exemplary embodiment, a user of the Time Miner application may enter or select at least one billing time setting. For example, the billing time setting may correspond to a time increment, a billing increment, or a fixed fee value. The billing time setting may be associated with one or more contacts, for example as a default setting associated with a contact, or may be entered according to each billing entry or billing characteristic (e.g., according to a particular type of correspondence, a specific type of document, a specific length of time or work performed according to a particular task, etc.). In one exemplary embodiment, the billing time setting corresponds to a billable hour billing rate associated with a user of the Time Miner application. For example, the billing time setting may correspond to a 0.1 factor when the user bills time according to a one-tenth hour increments, and the billing time setting may correspond to a 0.25 factor when the user bills time according to quarter-hour increments. When the billing time setting corresponds to an hourly billing setting of a user, the hourly billing setting may be applied across all contacts, or may be applied to one or more contacts according to a default setting or designation provided by the user.

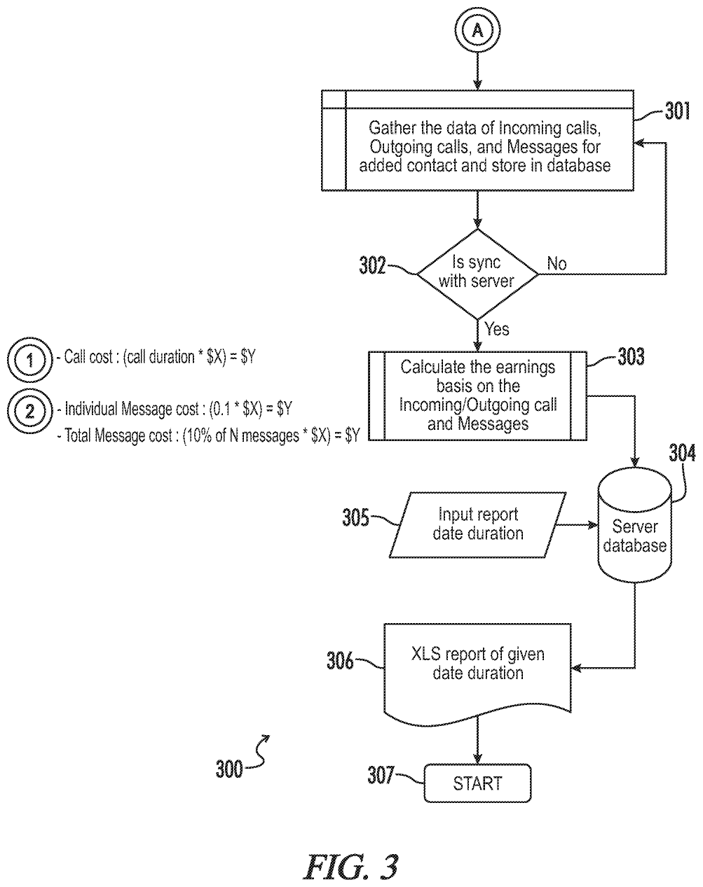

If a contact has not been added, the process continues to a set 213 where the contact is added. If it is determined at the step 211 that a contact has not been added, the process continues to a step 212, where all contacts associated with a user account are fetched. For example, all contacts associated with the user of the time miner application 130 may be retrieved. The process then continues to the method 300 of FIG. 3.

FIG. 3 illustrates a process for collecting and associating data in accordance with an exemplary embodiment. The process 300 begins at a step 301 from the previously-described step 212. At step 301, at least one of incoming call data, outgoing call data, and/or electronic messages for a particular contact may be gathered and/or stored in a database (e.g., via at least one the databases 140, 150, and 160). The process then continues to a step 302, where it is determined whether data associated with the Time Miner application 130 is synchronized with server data. For example, it may be determined whether one or more gathered and stored data entries correspond to a current or previously billed time entry corresponding to the contact. If the data is not synchronized, the process returns to the step 301. If synchronized with the server, the process continues to a step 303, where an earnings basis of at least one of the incoming call data, the outgoing call data, and/or the electronic message(s) are calculated.

In one exemplary embodiment, the Time Miner application may be configured to include the ability to use voice-over-IP (VoIP) data and/or VoIP metadata associated with a user device in place of call log information. For example, VoIP data and/or metadata may be mined according to real-time VoIP data and/or stored VoIP data and metadata. The VoIP data and metadata may be associated with one or more telephone calls in one exemplary embodiment. Although described with reference to VoIP data and metadata, it should be appreciated that the Time Miner application may be configured to work with any third-party application or protocol configured to convey voice information and/or data from or to a user device. In one embodiment, the Time Miner application may implement one or more plug-ins configured to enable operation with one or more specific applications, protocols, or communication methods. The one or more plug-ins may be manually specified by a user or administrator, may be bundles according to default installation packages, or may be automatically selected and/or implemented within the Time Miner application, or a combination thereof.

The process continues to a step 304, where the calculated earnings basis is stored in a server database (e.g., storage 172 of server 170). Additionally or alternatively, the calculated earnings basis may be stored at the computing device, for example at the storage 125. After being stored, the data may be queried, for example by using a time limited search at a step 305. Additionally or alternatively, one or more of a user, a client, a time period, a start data, an end date, a matter number, a document type, a service type, or any other criteria may be specified, either alone or in combination, to search stored information. After identifying information relating to the search, relevant information or metadata concerning the relevant information may be returned to the Time Miner application 130 for presentation to and/or selection by a user at a step 306 (e.g., via a Microsoft Excel report according to a particular search criteria). After presentation and/or selection to the user of the Time Miner application, at least one set of time information may be entered into a billing software module, either manually or automatically. For example, in one embodiment, time entry data selected by a user of the Time Miner application 130 may be automatically populated into billing software used by a user of the Time Miner application 130, thereby reducing the time and burden of time data entry. The process may conclude at a step 307.

In one exemplary embodiment, the Time Miner application 130 is configured to scan a computing device 110 for tagged or otherwise identifiable tasks or actions to create a time entry for the tasks or actions. For example, if the Time Miner application 130 finds that a user has written a letter to someone (e.g., a one-page letter), the Time Miner application 130 may create a dated time entry that listing, for example, “correspondence to J. Smith,” and assign a time value of 0.3 hours. A value of 0.6 hours may be assigned to a letter having two pages, and so on. As such, implementations consistent with the present disclosure may eliminate the need for contemporaneous time entries in favor ho merely selecting a button at the end of the month and having all time entries created and deliverable in an invoice format at the end of the month or billing cycle.

The Time Miner system described herein provides a way for simply scanning a computing device for one or more communications and tasks, and producing and e-mailing reports which can then be used to create time entries. The Time Miner system is capable of importing a current client, case, and/or matter contact list containing at least one of names, numbers, and e-mail addresses such that time entries for personal communications on a computing device might not be included in the report. As such, the contact list is capable of being updated as clients will come and go over time, and matters will be added and removed. In one exemplary embodiment, a report may be e-mailed to an attorney or secretary, who then may input time entries into a time/billing software. Additionally or alternatively, the Time Miner application 130 may be configured to synchronize with one or more time/billing platforms (e.g., Clio, Rocket Matters, Timeslips, PCLaw, etc.) and may automatically generate actual time entries into the time/billing software, for example with descriptions such as “three (3) text messages to/from Jane Doe” and an associated amount of time. In one embodiment, the automated functionality may be provided as an add-on to an existing time/billing platform. The Time Miner application 130 may be configured as a one-time purchase, and/or may be provided under a license or subscription model. For example, a monthly charge may be required to use the Time Miner application 130.

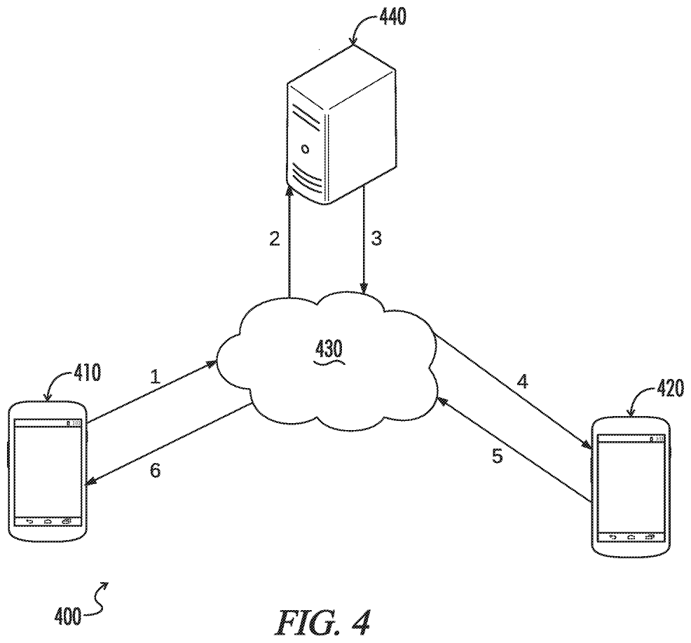

FIG. 4 illustrates a network configuration for implementing and mining an electronic communication according to aspects of the present disclosure. The system illustrated in FIG. 4 may be used, for example, when access to local data such as call logs or e-mails may not be accessible at a user device. For example, some mobile device manufacturers may limit third-party applications from accessing call logs or e-mail on a mobile device, thus a solution is needed to track and/or obtain mineable information from the mobile device. The system 400 includes a first electronic device 410 and a second electronic device 420. In one exemplary embodiment, at least one of the first electronic device 410 and the second electronic device 420 is a computing device 110 as previously described herein. The first electronic device 410 and the second electronic device 420 may be coupled to a communications network 430. The communications network 430 may be equivalent to a network 190 as previously described herein. The first electronic device 410 and the second electronic device 420 may be configured to communicate with one another using one or more communications mediums, such as the communications network 430 (for example, using the Time Miner Application 130 and/or other application or hardware or software capability of at least one of the first electronic device 410 or second electronic device 420, whether stored either locally or remote to the physical device). Although illustrated as a single network, it should be appreciated that the communications network 430 may include one or a plurality of networks therein without departing from the spirit and the scope of the invention.

At least one of the first electronic device 410 and the second electronic device may be configured to communicate with a server 440 via the communications network 430. The server 440 may be configured to provide an API for creating and/or maintaining communications between the first electronic device 410 and the second electronic device 420. In one exemplary embodiment, the server 440 is configured to provide a representational state transfer (REST) web service. Additionally or alternatively, at least one operation associated with the server 440 may be implemented, for example, using a web services description language (WSDL) implementation, a simple object access protocol (SOAP) implementation, or any other web service-based implementation. In one embodiment, the server 440 is configured to perform one or more operations according to a client-server model, a distributed computing implementation, or any other communications model or protocol permitting one or more electronic messages to be communicated between two or more of the first electronic device 410, the second electronic device 420, the communication network 430, and/or the server 440. The server 440 may be configured to provide a REST API for establishing or maintaining communications between the first electronic device 410 and the second electronic device 420 in one embodiment.

The server 440 may be a VoIP facilitation server in one exemplary embodiment. The server 440 may be configured to provide a REST API for providing VoIP services facilitating communications between the first electronic device 410 and the second electronic device 420. In various embodiments, at least a portion of operations associated with the server 440 may be provided by a third-party API provider, such as Twilio, Callfire, Rebtel, or any other third-party providing an API capable of providing electronic communications to a user. Additionally or alternatively, at least a portion of the operations associated with the server 440 may be implemented by the Time Miner Application 130 provided by at least one of the first electronic device 410 and the second electronic device 420. For example, in one embodiment the Time Miner Application 130 includes one or more VoIP operations for communicating via VoIP (e.g., for establishing a VoIP call between the first electronic device 410 and the second electronic device 420).

A VoIP call establishment process may begin by the first electronic device 410 transmitting a connection request to the network 430 at step 1. The connection request may include a unique identifier. The unique identifier may uniquely identify at least one of a first user of the first electronic device 410, a second user, the second electronic device, a web service, a server address, an IP address, or any other identifier which may be used to uniquely identify any user or device. In one exemplary embodiment, the unique identifier is a telephone number associated with at least one of the first user device 410 or the second user device 420. Additionally or alternatively, the unique identifier may include an account identifier associated with at least one of a user and/or at least one of the first electronic device 410 or the second user device 420 (such as an e-mail address, a user login, etc.).

The connection request may be transmitted from the communication network 430 to the server 440 at step 2. The server 440 may be configured to parse the connection request to determine the unique identifier. Using the unique identifier, the server 440 may be configured to determine a user account or device associated with the unique identifier. For example, the server 440 may be configured to receive a telephone number as a unique identifier and identify an account and/or a second electronic device 420 associated with the unique identifier. The connection request may be associated with a webhook or other stateful or stateless communication method in various embodiments. The server 440 may be configured to communicate a call establishment request to the communication network 430 at step 3 including at least one of the unique identifier and/or an identifier of the determined user account or device. The call establishment request may be transferred from the network 430 to the second electronic device 420 at step 4.

The second electronic device 420 may be configured to receive the call establishment request and optionally convey a representation of the request to a user of the second electronic device 420 (e.g., via the Time Miner Application 130). In one exemplary embodiment, the user of the second electronic device 420 may be provided an option to accept or decline the call establishment request. In one exemplary embodiment, the second electronic device 420 may be configured to automatically accept or otherwise create a connection based upon a received call establishment request. Whether automatically performed or upon input from a user of the second electronic device 420, a connection creation message may be transmitted from the second electronic device 420 to the communication network 430. In one exemplary embodiment, the connection creation message may be transmitted directly to the first electronic device 410 from the second electronic device 420, using at least one of information included in the call establishment request and/or from a database stored at or otherwise accessible to the second electronic device 420. Additionally or alternatively, the connection creation message or an alternative message may be transmitted from the second electronic device 420 to the server 440. The first electronic device 410 may be configured to form a communication session across the communication network 430 with at least one of the second electronic device 420 and/or the server 440 responsive to the connection creation message.

The server 440 may be configured in various embodiments, to track and/or maintain state associated with a VoIP call between the first electronic device 410 and the second electronic device 420. For example, the server 440 may be configured to track call establishment, disconnection, duration, or any combination thereof. Additionally or alternatively, at least one of the first electronic device 410 and the second electronic device 420 may be configured to transmit at least one set of mineable data to a third-party service or server. For example, the first electronic device 410 may be configured to store at least a portion of call log data and/or e-mail data via a third-party, such as a back-up server or service (e.g., via an iCloud service or the like). A user of the first electronic device 410 may be requested to permit access to the at least one set of mineable data associated with the third-party service or server, and/or the Time Miner Application 130 may be capable of obtaining the at least one set of mineable data without first receiving explicit user authorization.

In one exemplary embodiment, the Time Miner Application 130 is capable of variously communicating using traditional cellular telephone methods associated with at least one of the first electronic device 410 and the second electronic device 420, and mining data associated therewith (e.g., via obtaining a local call log). Additionally or alternatively, the Time Miner Application 130 may be capable of either implementing a VoIP function or accessing a VoIP API to implement mineable call data. In various embodiments, the Time Miner Application 130 and/or server 440 may be capable of accessing either or both of stored call data and VoIP call data.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims. The phrase “in one embodiment,” as used herein does not necessarily refer to the same embodiment, although it may.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The previous detailed description has been provided for the purposes of illustration and description. Thus, although there have been described particular embodiments of a new and useful invention, it is not intended that such references be construed as limitations upon the scope of this invention except as set forth in the following claims.

What is claimed is:

1. A non-tangible computer-readable storage medium having instructions stored thereon, which when executed by a processor perform the steps of:
selecting at least one billing criteria by a user of a mobile device;
searching for stored electronic communication data related to the at least one billing criteria;
returning at least one matched electronic communication from among the stored electronic communication data relates to the at least one billing criteria;
assigning at least one of a time value and a billing value to the at least one matched electronic communication; and
performing at least one of timekeeping and billing based upon the assigned at least one time value and billing value.

2. The non-tangible computer-readable storage medium of claim 1, wherein the searching for stored electronic communication data comprises searching the mobile device for locally-stored electronic communication data.

3. The non-tangible computer-readable storage medium of claim 2, wherein the stored electronic communication data includes telephone call data.

4. The non-tangible computer-readable storage medium of claim 2, wherein the stored electronic communication data includes electronic mail data.

5. The non-tangible computer-readable storage medium of claim 1, wherein the searching for stored electronic communication data comprises accessing a data storage external to the mobile device and obtaining at least one set of electronic communication data.

6. The non-tangible computer-readable storage medium of claim 5, wherein the stored electronic communication data includes telephone call data.

7. The non-tangible computer-readable storage medium of claim 5, wherein the stored electronic communication data includes electronic mail data.

8. An apparatus for providing mined time information, the apparatus comprising:
a display interface, the display interface being configured to convey a set of one or more billing criteria;
an input module, the input module configured to receive a selection of at least one of the one or more billing criteria;
a mining module, the mining module being configured to obtain one or more electronic messages corresponding to the selected at least one of the one or more billing criteria; and
a billing module configured to perform at least one of timekeeping and billing based upon an assigned billing value corresponding to the selected at least one of the one or more billing criteria.

9. The apparatus of claim 8, further comprising a local storage, the local storage configured to store at least one set of mineable data,
wherein the mining module is configured to obtain from the local storage the one or more electronic messages corresponding to the selected at least one of the one or more billing criteria.

10. The apparatus of claim 9, wherein the local storage is configured to store at least one set of telephone call data, and wherein the mining module is configured to obtain the at least one set of telephone call data.

11. The apparatus of claim 9, wherein the local storage is configured to store at least one set of electronic mail data, and wherein the mining module is configured to obtain the at least one set of electronic mail data, wherein the stored electronic communication data includes electronic mail data.

12. The apparatus of claim 8, wherein the mining module is configured to obtain the one or more electronic messages by accessing a data storage external to the mobile device and obtaining at least one set of electronic communication data.

13. The apparatus of claim 12, wherein the stored electronic communication data includes telephone call data.

14. The apparatus of claim 12, wherein the stored electronic communication data includes electronic mail data.

15. A method of providing mining of time data on a computing device, the method comprising:
selecting at least one billing criteria by a user of the computing device;
searching for stored electronic communication data related to the at least one billing criteria;
returning at least one matched electronic communication from among the stored electronic communication data related to the at least one billing criteria;
assigning at least one of a time value and a billing value to the at least one matched electronic communication; and
performing at least one of timekeeping and billing based upon the assigned at least one time value and billing value.

16. The method of claim 15, wherein the searching for stored electronic communication data comprises searching the computing device for locally-stored electronic communication data.

17. The method of claim 16, wherein the stored electronic communication data includes telephone call data.

18. The method of claim 16, wherein the stored electronic communication data includes electronic mail data.

19. The method of claim 15, wherein the searching for stored electronic communication data comprises accessing a data storage external to the computing device and obtaining at least one set of electronic communication data.

20. The method of claim 19, wherein the stored electronic communication data includes telephone call data.

21. The method of claim 19, wherein the stored electronic communication data includes electronic mail data.
